(19) United States
(12) Patent Application Publication
(10) Pub. No.: US 2002/0002560 A1
(43) Pub. Date: Jan. 3, 2002

(54) Method and system for collecting diverse data types within a manufacturing environment and accessing the diverse data types through a network portal

(76) Inventors: Snehanshu Shah, Austin, TX (US); Sunit Gala, Burlingame, CA (US)

Correspondence Address: HIVETECH, INC., 1702 MEADOWBROOK DRIVE, AUSTIN, TX, 78703, US

(21) Appl. No.: 09/896,170

(22) Filed: Jun. 29, 2001

Related U.S. Application Data
(60) Provisional application No. 60/215,490, filed on Jun. 30, 2000.

(51) Int. Cl. G06F 17/30

(52) U.S. Cl. 707/200; 700/73; 707/104.1

(57) ABSTRACT

The present invention provides a system for dynamically publishing diverse data in a manufacturing environment. This system comprises diverse data sources from which raw data is gathered. Translators then translate the raw data into a user-specified format. The translated raw data is then loaded into an application server. A summarization engine indexes the translated raw data and maintains the index within a relational database. This data is then navigable by a user interface from which a user inputs a request for data. Software instructions executed by the application server retrieve and display the translated raw data relating to the requested data.

Additional embodiments incorporate both analysis tools coupled to the application server operable to perform analysis and visualization tools to visualize the translated raw data relating to the requested data via the user interface.

### RELATED APPLICATIONS

This application claims priority to U.S. provisional patent application Ser. No. 60/215,490 filed Jun. 29, 2000, entitled “A METHOD AND SYSTEM FOR COLLECTING DIVERSE DATA TYPES WITHIN A MANUFACTURING ENVIRONMENT AND ACCESSING THE DIVERSE DATA TYPES THROUGH A NETWORK PORTAL,” which is incorporated herein by reference.

### TECHNICAL FIELD OF THE INVENTION

This invention relates generally to systems and methods for analyzing data. More specifically, the present invention relates to systems and methods for gathering, storing, analyzing and visualizing diverse data sets collected within a manufacturing environment.

### BACKGROUND OF THE INVENTION

In a typical manufacturing environment, there is a large amount of data coming from many diverse sources within a fabrication facility. Further complicating this is that larger companies have multiple fabrication facilities with still more data. This makes the proper analysis and understanding of the data extremely difficult. Before one can use the data to make decisions, the information needs to be managed and presented in a format that aids the decision-making process. This allows users to make conclusions and decisions that transform into profitable action. A critical success factor for these manufacturing facilities is the ability to take quick action and make quick and correct decisions. This factor depends on the ability to quickly and smartly process this data to provide high quality of information.

Questions often arise as to whether or not the infrastructure within the manufacturing facility is flexible and allows users and decision makers to make quick decisions and act on them. The solutions available today are usually in-house custom solutions and report analysis software. Additionally, there are a large number of manufacturing equipment status software packages available that allow one to quickly view the status of manufacturing equipment. However, for reviewing the status of product and the yield and defectivity analysis associated with that product, people typically are manually extracting and parsing data into commercial applications such as Excel, Cornerstone, JMP, or are developing in-house analysis tools still dependent on these commercial general purpose tools. Typically commercial yield analysis tools turn out to be user-specific solutions. These solutions are good for one class of data or one class of problem. Most engineers typically end up learning several systems in order to extract data from one system, parse that data into the desired format with a second application, analyze that data with a general purpose tool such as Excel or JMP, and still rely on yet another software package for visualizing the data and generating the appropriate reports. Thus, the engineers and users have to learn several systems and techniques associated with raw data extraction, in-depth analysis and report generation. Furthermore, these reports are user-specific and often inconsistent.

It would be desirable to be able to form a root cause analysis quickly with a total data management tool, the idea being that one would be able to manage and look at data from a single consistent unit, meaning having a tool capable of incorporating analysis techniques, data extraction techniques and templates to properly format the data for analysis in one place. Thus a user or engineer would only be required to access one software tool, as opposed to data from multiple places that is analyzed with multiple software tools.

It would be even more desirable then to build closed-loop control solutions with a total data management system that is integrating the collected data and incorporate this into the decision-making process. Today, when a problem occurs, product or assembly lines stop, manufacturing equipment is shut down, and people scramble trying to figure out what happened. Often, problems are not detected because the reports are not generated and the product fails with the end user down the road. Commonality analysis is typically done by hand to identify potential problem tools, products, or processes.

It would be desirable to integrate all available data sources at the same time in an extendable and scalable environment. This would allow manufacturing companies to have their processes continue to grow and maintain their processes in control and develop better controls and a better understanding of these processes.

Furthermore, it would be desirable to reduce costs associated with in-house solutions to these problems. This would allow one to reduce operating costs by avoiding large expenditures on the part of administrators and users in maintaining a system. Today's in-house solutions are focused on a single problem and are typically not interactive or have larger reporting capabilities. Commercial systems are focused on particular data areas, such as yield management in the semiconductor industry. There are many systems for detecting defect and there are some for electrical tests and wafer sorting. However, these systems are all closed, as the view that most vendors have taken is that their system solves all problems. This creates another issue in that most companies have a tremendous amount of intellectual property associated with this data that is untapped because the proper tools for navigating and generating reports from that data have not been made available to the users.

Furthermore, it would be desirable to have a system that is capable of outputting data in an HTML format to a web browser, thus allowing users to not rely on local tools to analyze data but rely only on having network access to visualize and analyze their data.

A final detractor associated with the present systems is that the knowledge obtained by the individual engineers is lost through attrition and required to be re-learned with new systems and users generating their own unique templates.

### SUMMARY OF THE INVENTION

This invention relates generally to systems and methods for analyzing data. More specifically, the present invention relates to systems and methods for gathering, storing, analyzing and visualizing diverse data sets collected within a manufacturing environment.

More specifically, the present invention provides a system for dynamically publishing diverse data in a manufacturing environment. This system comprises diverse data sources from which raw data is gathered. Translators then translate the raw data into a user-specified format. The translated raw data is then loaded into an application server. A summarization engine indexes the translated raw data and maintains the index within a relational database. This data is then navigable by a user interface from which a user inputs a request for data. Software instructions executed by the application server retrieve and display the translated raw data relating to the requested data. Additional embodiments incorporate both analysis tools coupled to the application server operable ID perform analysis and visualization tools to visualize the translated raw data relating to the requested data via the user interface.

### BRIEF DESCRIPTION OF THE DRAWINGS

A more complete understanding of the present invention and the advantages thereof may be acquired by referring to the following description, taken in conjunction with the accompanying drawings in which like reference numbers indicate like features and wherein:

FIG. 1 illustrates a first embodiment of the present invention;

FIG. 2 illustrates a second embodiment of the present invention;

FIG. 3 provides a flow chart depicting the method of the present invention;

FIG. 4 illustrates a dynamic web application;

FIG. 5 illustrates broadly the architecture of the present invention;

FIG. 6 provides an example of the different database tables within correlation database;

FIG. 7 illustrates typical standard reports for a manufacturing plant;

FIG. 8 depicts the system architecture of the present invention;

FIG. 9 shows how data may be loaded from diverse data sources to the application server of the present invention; and

FIGS. 10A-C depict various variable types and summaries associated with semiconductor manufacturing.

### DETAILED DESCRIPTION OF THE INVENTION

Preferred embodiments of the present invention are illustrated in the FIGUREs, like numerals being used to refer to like and corresponding parts of various drawings.

The concept behind the present invention is applicable to any sort of manufacturing facility where multiple systems are collecting data in conjunction with a possible manual collection of data, as well. In such a manufacturing facility, engineers and process managers are often trying to make decisions quickly. Any deviation from the normal process may require a decision about the associated product. In the semiconductor industry, the may be a low-yielding lot of wafers or die that indicate a potential manufacturing problem within the process. To determine the manufacturing problem, one needs to access data in a consolidated way. This is because in a manufacturing process such as the semiconductor industry, where multiple process steps are required to complete the product, deviations from any of these sub-processes may cause a failure in the overall manufactured product. Therefore, process, product, and device engineers are often required to analyze the data associated with the individual processes to make a determination as to the cause of failure for the product and thereby prevent the failure from happening again.

The ability to do this fault analysis in a timely manner requires that data be consolidated. Typical prior art systems build a monolithic system that touches on everything. However, it is difficult to build an analysis system that does everything, so typical prior art systems require an engineer to conceptualize multiple systems. For example, the data an engineer may require may be extracted from data system 1, reformatted for data system 2, parsed for data system or application 3, and then compared with similar data prepared with the help of systems D, E and F. Then the engineer can perform the analysis, visualize the data, or create a report from which decisions are made or hypotheses are formed as to what may have happened.

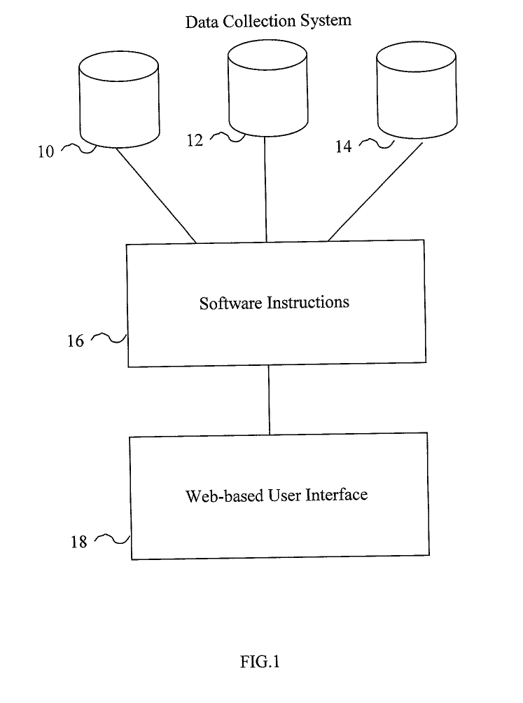

The present invention provides a manufacturing portal. This is a system that has an inherent capability to provide a large degree of reporting and analysis, but its basic function is to provide a consolidated view to the user. Basically, the present invention integrates the reports available from data collection systems 10, 12, 14 for multiple data collection systems such as those illustrated in FIG. 1 as data collection systems 10, 12 and 14. The software engine of the present invention integrates these reports with other similar systems through the set of software instructions 16 and outputs them to a web-based user interface 18. This has the advantage of providing an engineer or operator or other decision-maker a unified, consistent user interface 18. Simply, one does not need to worry about the source of the data or how the data is transferred from one system to another. Rather, one must only be trained on the operation of user interface 18.

Additionally, a report manager is capable of publishing, archiving, or providing a hard copy of a report of these integrated reports from the various data sources as illustrated by data sources 10, 12 and 14. Essentially, there are four to five types of reports that are used in a semiconductor-manufacturing environment. However, there is no system of managing these reports. What typically happens is either they are published to a disk, published to a web site, or printed and filed away. The report manager of the present invention allows this data to be captured and therefore filed into a special location. Therefore, along with the processing data, the manufacturing hierarchy information is saved, and when a lot is identified for this type of data capture at a particular operation, the report manager can flag and store this data as it is collected during the manufacturing process. Additionally, search tags or Meta tags can be added to this data to facilitate the search process. Therefore, in the same way one would search Yahoo! for information, one can actually go back and search for data associated with a yield problem. The report manager in the present invention basically allows report information to be captured about how decisions were made.

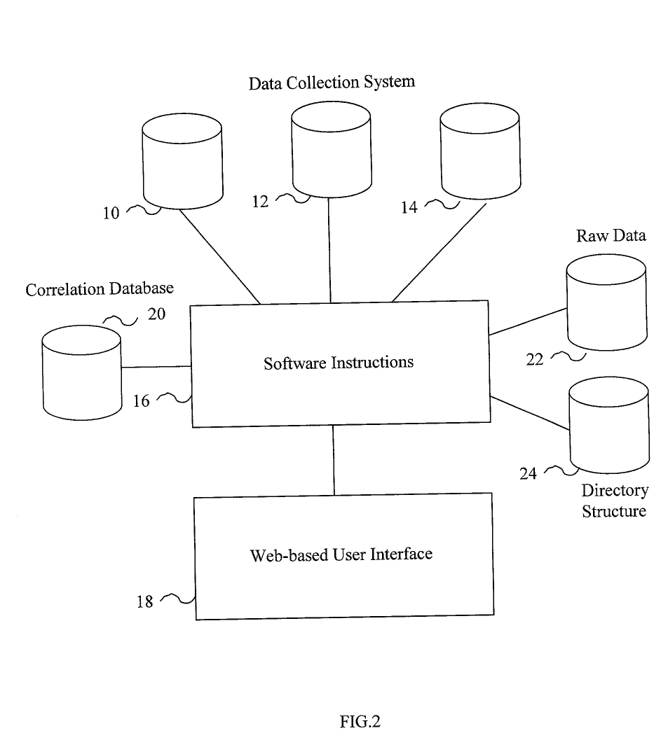

Another aspect of the present invention is the reporting end. It is possible with the system and method of the present invention, to integrate to existing infrastructure. For example, processing facilities typically have large databases with all kinds of yield and process data. Therefore, the historical data, to a limited extent, is already available. Therefore, with the present invention, it is possible to build a hybrid database based on capturing information about relationships between different things. The present invention allows the raw data files to be accessed even if they are in external databases. For example, if one was manufacturing semiconductor devices and one needed to look at the contact resistance, one may also be able to look at the metrology sheet resistances associated with specific lots for a specific period of time or similarly extract photo information about the critical dimensions associated with the various metal layers. This is an example of three different pieces of information—the sheet resistance, the contact resistivity, and the photo critical dimensions—that are typically stored in three different places. Where this data may be stored in a commercial product, for one, and then a specially built internal product for another, or some type of binary file. Here, the process engineer must integrate the processes, parse the data and collect the data manually. The system of the present invention would translate all of the data into a set of raw and summary files. These would be kept within a core relational database. The advantage of maintaining the summary files within the core relational database is that it allows one to navigate among the data files quickly. This architecture is illustrated in FIG. 2, wherein data collection sites 10, 12 and 14 are summarized by the software engine 16 where the summaries are in turn stored within a core relational database 20. Raw data may be accessible from the data collection sites 10, 12 and 14 or additional databases 22. The user can then navigate and access the data via user interface 18. The core relational database prevents the database from becoming extremely large and un-navigable by maintaining the summaries within the core relational database 20 and the raw data within additional databases 22. Additionally, this raw data may be stored as flat files, ASCII files or some other format files within a conventional file storage system outside of a database, where only the location and relationship of that data is maintained within the core relational database 20.

The flat files may be stored within a directory structure 24. There are a lot of prior art technology and methods for managing information within a directory structure. In a semiconductor environment, this may consist of a hierarchy based on the product, the lot, the operation, and the wafer having paths and sub-paths therein. Essentially, this becomes a large directory tree at which the ends of the branches consist of the flat files. The core relational database 20 has the index information and those relationships. Therefore, if one wanted to correlate the lots that had a product yield of less than 40% and were processed on a particular etcher, one could simply input that inquiry via user interface 18 and software engine 16 would access the core relational database 20 to determine those files, and after those files had been identified, software engine 16 could access additional databases 22 or directory structures 24 to access the raw data, which it would then integrate and visualize to the end user at user interface 18.

The present invention provides an important advantage over prior art systems in that software engine 16 serves to collect the raw data and maintain the relationships associated with the different raw data files. Software engine 16 also serves as a portal to allow this data from many diverse data collection systems 10, 12 and 14 that are integrated seamlessly into one user interface 18. This can be extended beyond a single factory to many diverse applications, such as where in the semiconductor industry parts and even individual processes are outsourced to foundry or specialty operations, or where geographically diverse operations are used in the processing of a single product. Therefore, traditionally, when a product is outsourced for an individual operation, when it is returned to the processing facility, a hard table or printout of the data associated with that operation is returned with the product. Similarly, a semiconductor device completed at the fabrication facility may be shipped to an assembly facility where it is actually bonded to external wires and packaged. It would be desirable to be able to integrate this data with the data from the processing facility to have a better understanding of failures mechanisms within the device.

The web-based application or user interface of the present invention allows software engine 16 to maintain the connections to data collection systems 10, 12 and 14, relational database 20, additional databases 22, or file structures 24, and user interface 18 via network connections. These network connections may be an Internet, Intranet, or other network known to those skilled in the art. This allows software engine 16 to operate remotely from and without a dedicated network to any one component of the present invention. Rather, as long as the various components are capable of establishing a network or Internet connection, then software engine 16 is able to integrate the data. Additionally, user interface 18 may simply be a user interface where the computing is done at software engine 16 and only visualized with user interface 18. Thus, reducing the computational requirements of the system that is operating user interface 18. User interface 18 may be operated from any platform capable of establishing a network or Internet connection with software engine 16.

Basically, software engine 16 is provided with a URL for each of the various components associated with the data collection and management system of the present invention. Additionally, an engineer or other user accessing the system and method of the present invention need only be provided with a URL through which they may interface via a portal or user interface 18 to software engine 16.

The present invention provides reports or visualizes raw data to an end user. In the semiconductor industry, there are different types of reports that are often required. One example of these types of reports is a wafer mat. The reports are provided as templates and the templates use scripting language to create these reports.

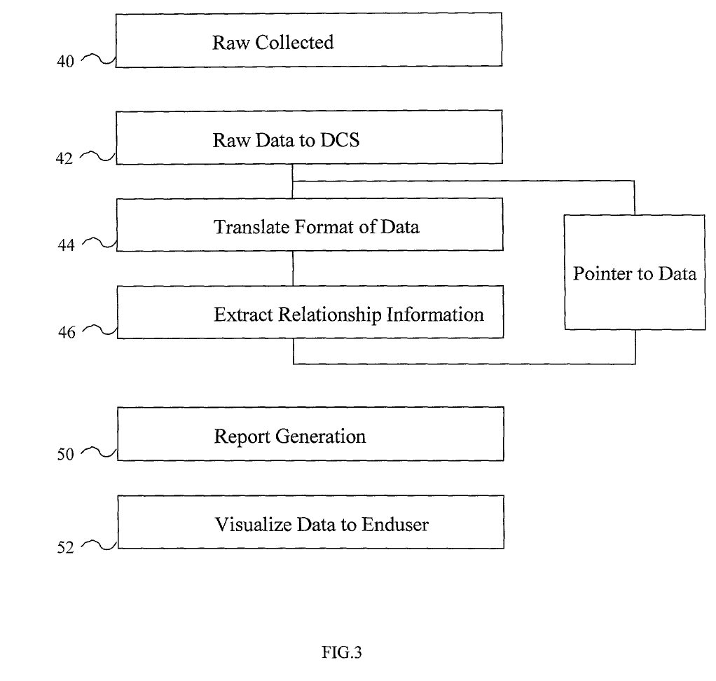

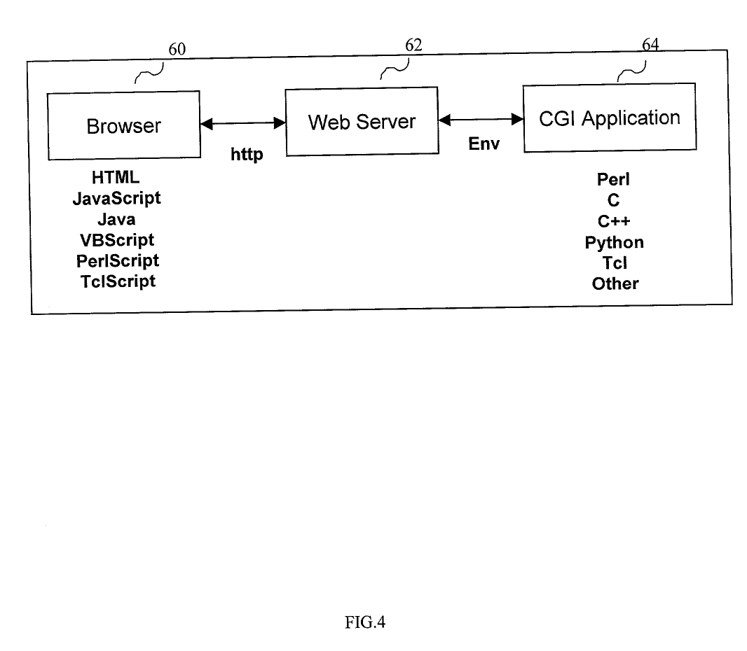

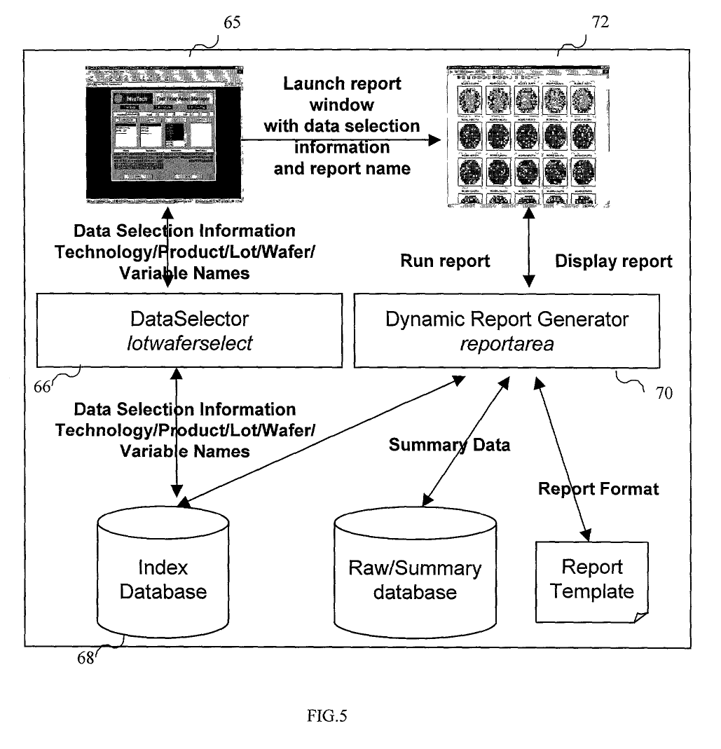

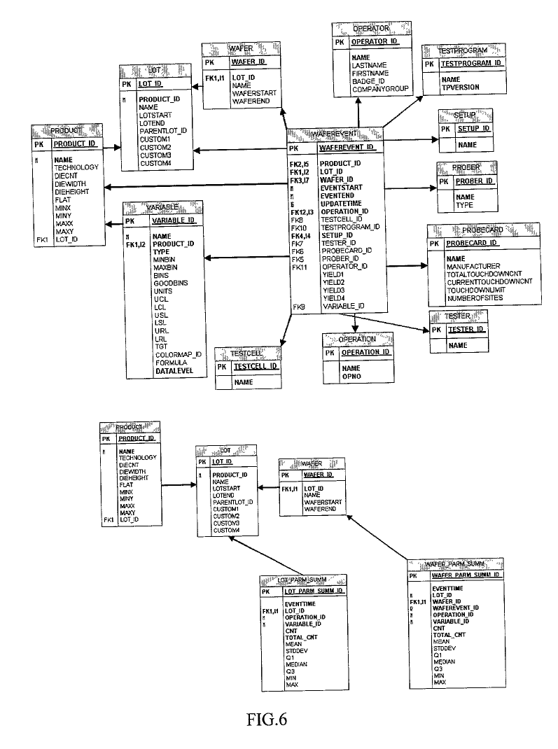

The process associated with the method of the present invention is illustrated in the flow chart provided in FIG. 3. In step 40, raw data is collected from a metrology tool or as a process variable. This raw data is sent in step 42 to the data collection systems 10, 12 and 14, as shown in FIGS. 1 and 2. In step 44, the raw data provided from the data collection systems to software engine 16 is translated into a format understandable by software engine 16. This translation may involve either the extraction of relationship information, which in turn is stored within the core relational database 20 in step 46, or the data may be managed and translated and stored in another database 22 or in a user-friendly format within directory structure 24. Similarly, a pointer or flag may be associated with the data as to where the actual raw data is located. Therefore, when a request for the raw data is received, software engine 16 may be directed to that raw data, in which case the translators within software engine 16 will translate and format data 44 as needed. The reason for doing this may be that not all data is required to be stored within databases 22 or data structures 24. Rather, in many cases this data is not used for analysis purposes, but a link to where that data is stored is valuable if the need to analyze that data should arise in the future.

In step 50, the report is generated which is visualized to the end user in step 52. This report generator may be based on the lot level, the product level, the tool level, or any other sorting criteria that the user may desire, such as by week, by month, by quarter.

Defectivity is another variable associated with products, particularly in the semiconductor-manufacturing environment. However, there are existing systems that manage defectivity. Therefore, the present invention maintains a link to them so that comparisons and reports can be generated relating defectivity data to yield data, probe data, test data. Additionally, the report manager of the present invention is valuable in comparing defectivity data to identify a common thread such as a lot, a product, a wafer or an individual tool, or perhaps even an individual operator associated with the defectivity.

The present invention may utilize data collection systems comprising databases or data loading systems wherein software engine 16 can detect automatically when new data has arrived and pull this data into the system. The configuration of the data collection source may determine whether or not this data is then in turn stored within another database 22 or data file structure 24. Whether or not the raw data is maintained within the data collection system 12 or needs to be maintained in a data storage facility accessible to software engine 16 is a function of configuration. Basically, once software engine 16 is connected to a data source 10, 12 or 14, software engine 16 monitors the data source. If the data source is a database, the database is polled for data on a recurring basis. If the database is a file created by measurement equipment, then software engine 16 monitors and sets up directories for those type files and automatically loads this in. The primary advantage for users being that, since software engine 16 is network or web based, it is completely platform independent and merely requiring that user interface 18 is operable on the platform that a user is using. Therefore, one would be able to access data with appropriate permissions from any place in the world. This is particularly valuable for disperse manufacturing systems where semiconductors may be produced at a foundry in a country such as Taiwan and assembled in Hong Kong for products that are ultimately assembled in the United States or where the engineers overseeing the process are located in a remote facility.

The present invention provides an open framework that enables one to create an information portal to all manufacturing data associated with a particular product. A series of report templates provides a valuable way of turning manufacturing data into information used to make profitable decisions. The reporting templates may be made with a programming language such as PERL or any other like programming language known to those skilled in the art.

The present invention is a dynamic web application. Most Internet and Intranet web sites today consist of web server publishing static HTML pages to users who view the pages using browsers. This is static web publishing.

Dynamic web publishing generates web pages based on user inputs. The way this happens is very simple. A user specifies interactive elements on web pages, such as list boxes, pull downs and the like, as known to those skilled in the art, to specify a collection criteria. The user's browser 60 then sends the input criteria to a web server 62. Web server 62 then passes the user selection criteria to programs 64 that generate dynamic pages. These programs are commonly called common gateway interface programs (CGI). A dynamic web application consists of one or more CGI applications that work together to provide the user with some defined functionality, such as manufacturing reporting. The present invention provides a simple, dynamic web application that consists of a set of CGI programs 64 that work in concert to provide manufacturing reporting to companies, such as semiconductor manufacturers. However, the present invention need not be limited to semiconductor manufacturing as any product, from an automobile manufactured by General Motors to tactical aircraft manufactured by Lockheed Martin, are all products from a manufacturing process which analysis of this process can provide a more robust product.

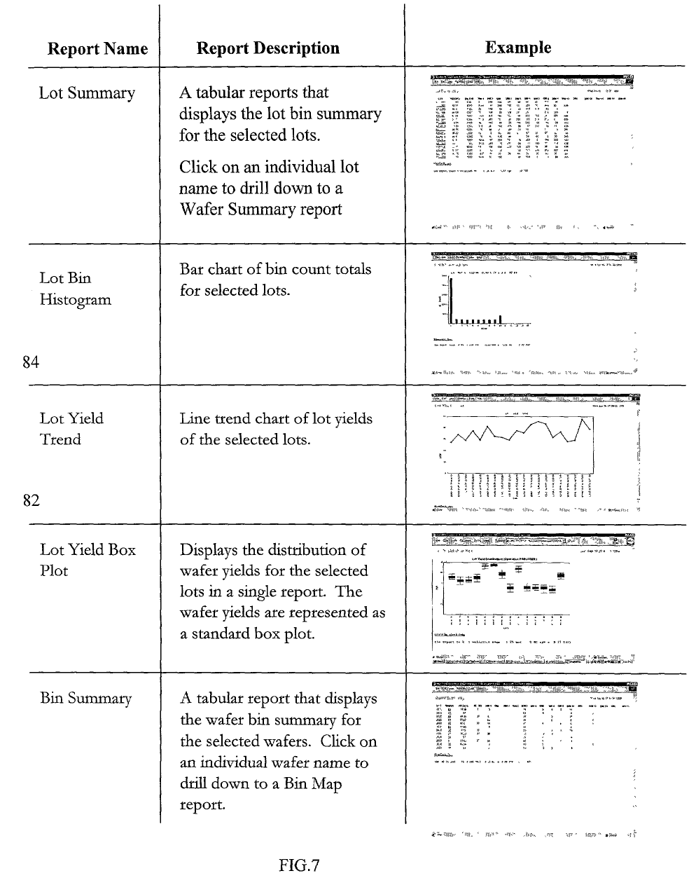

FIG. 5 illustrates how the present invention uses CGI programs 64 to generate reports. The data selector screen or user interface is used to generate the reports. In the semiconductor application, users first select lots and wafers of interest and pick a report that is then displayed in a separate web browser window. The data selector screen is generated by a CGI program 66. This program serves to interface to index database 68, which contains a list of all lots and wafers managed by the present invention. When the user interacts with the data selector screen, the user really interfaces with CGI program 66 and navigates the index database to select the lots and wafers of interest.

The data selector screen launches a separate web browser window to display reports when the user selects a report to be generated. This separate window is called the report window. DUH! The data selector screen passes the user's data selection and report information to a CGI program 70, then the data selector screen communicates with the report window using a language such as JavaScript. CGI program 70 first verifies the user data selection and report selection and then generates a report by running the appropriate report template. Report templates are small PERL programs that contain all the logic for generating a report given the data object oriented interface. In addition, the present invention provides some graphical objects to the report templates that enable them to generate graphs, wafer maps, charts, or other visualizations of the data, as known to those skilled in the art.

The output of the report template is an HTML web page that is then displayed in the reports window 72. Report templates are extremely flexible. For example, one can write a report template that runs a shell script. The only restriction for report templates is that they must output HTML web pages or another similar format that can be visualized by the graphical user interface. The HTML web pages can be information rich and interactive. They may include XML, GIF/JPEG images, Java applets, or VPSCRIPT applets. In reality, they can include anything that is supported by user interface 18 that the network allows.

FIG. 6 provides an example of the different database tables within correlational database 20. User interface 18 allows a user to select data from the index database exemplified in FIG. 6 and then, after the data has been selected, run a report through the appropriate template to provide the user the desired report through user interface 18.

The present invention provides an engineering analysis portal. The present invention is not focused on the analysis tool, but rather as a gateway to analysis tool and the centralized collection of analysis tools and data. In other words, the present invention provides a gateway to all manufacturing data that happens over time, integrating data from almost any data source. The present invention provides a relationship between raw data that is either stored within external data collection facilities or internal data management systems in a system of templates coupled to analysis tools that allow a user to generate consistent and customized reports on this data. The system of the present invention can either analyze data on demand or data that has been stored. For example, if there is data, which is typically not analyzed, the present invention may record a pointer to the data that is maintained in an external data collection facility. When the software engine of the present invention receives a request for the data, it will then extract that data from the external data collection facility and generate the user-specified report based on internal templates and analysis tools. Furthermore, some reports required on a daily basis may be automatically generated based on data that is automatically collected, analyzed and visualized based on a set of rules provided by or stored within the software engine of the present invention. This eliminates the need for individuals to manually access individual files for yield status and potentially manually verify the conditions of various tools and report these or consolidate these into a user generated report.

Data navigation associated with user interface 18 is web-based and based on a graphical user interface. In the semiconductor environment, one can simply decide that one would desire to navigate by technology, device, operation, lot, wafer and other like variables. But this navigation could be changed very easily. This navigation could be changed very easily; for example, if one wanted to navigate based on equipment, a date range, or other like variable. The template format for the user interface provided by the present invention is simple and allows customized user interfaces to be created with the exact look and feel for the exact navigation that decision makers or users may desire. For example, a certain class of engineers are more interested in equipment or a particular module or process and are not interested in the lots and wafers. Others, such as manufacturing specialists, may be more interested in what is happening over time, while a device or produce engineer may be more interested in the individual devices on an individual wafer or on a particular product and its individual parameters.

The present invention also allows data to be extracted from a native database of the present invention or formatted by the present invention and exported to a third party tool for analysis. Alternatively, general tools can be incorporated into software engine 16, allowing the analysis to be specified by the user via user interface 18 and actually performed within software engine 16.

In summary, the engineering analysis portal and framework of the present invention allows users to create specific customized tools and reports on a common framework. Therefore, the tool or the present invention becomes common to all users and allows users to simply have one user interface for a variety of data sources, data management systems, and analysis tools.

The present invention provides an important advantage in that it is modular and scalable in that a variety of data management.

Modularity provided by the present invention comes in two levels. The idea is that the present invention is capable of integrating diverse data sources and that one is not locked in to the type of data sources from day one. Modularity is in two levels. First, one can create custom modules or customize off-the-shelf modules in the sense that one can add different kinds of data one at a time, not necessarily all at once. For example, if there is a new foundry partner or a new assembly house, it is possible to plug and play that type of data, as a data collection source, into software engine 16. Furthermore, the users at the data collection source, with the right permissions, will have the same access as any other user so long as that user is capable of displaying via network connection user interface 18.

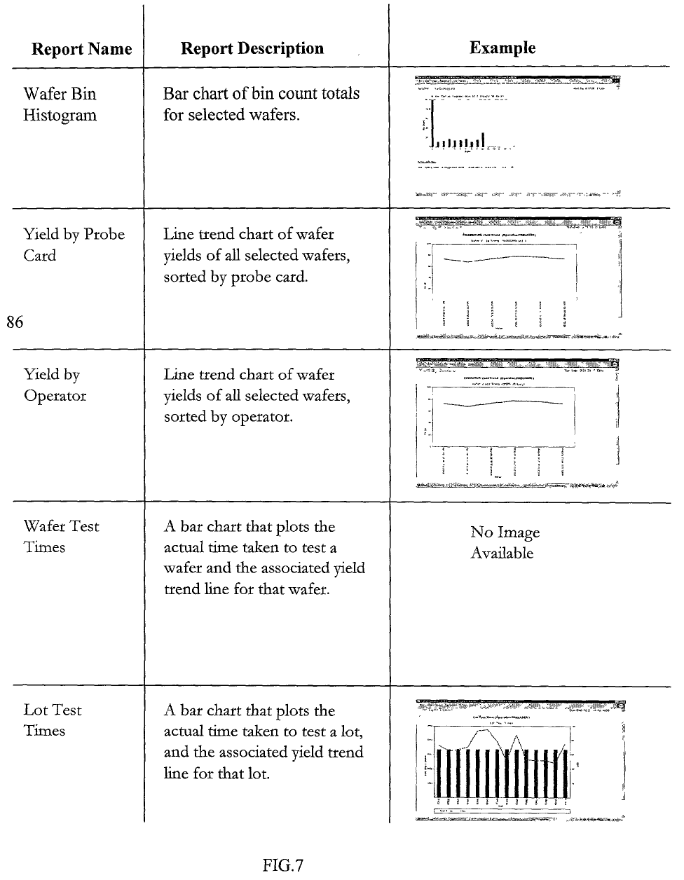

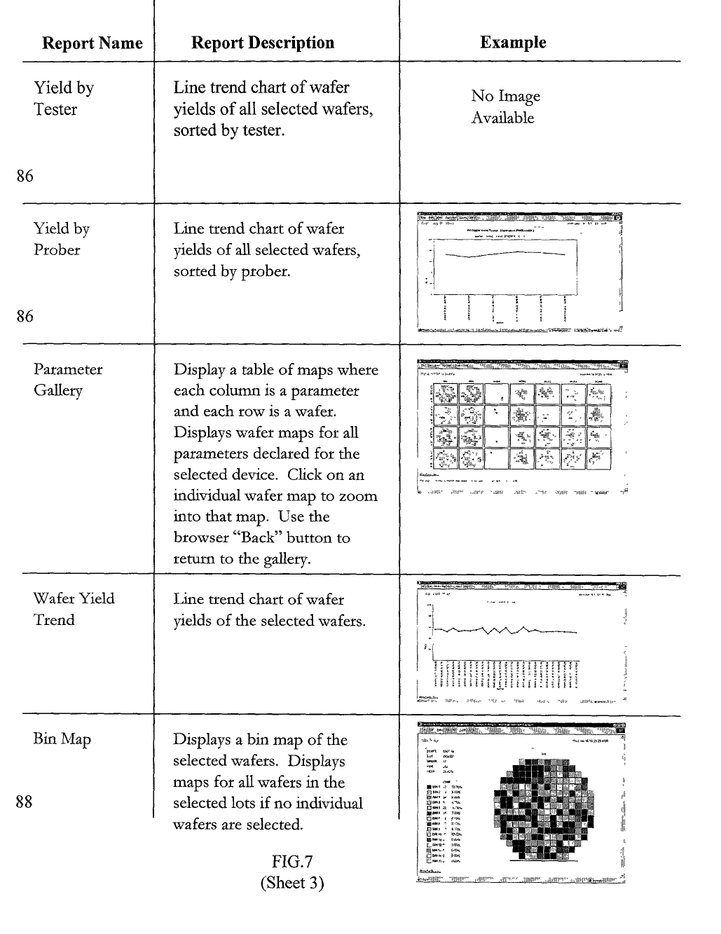

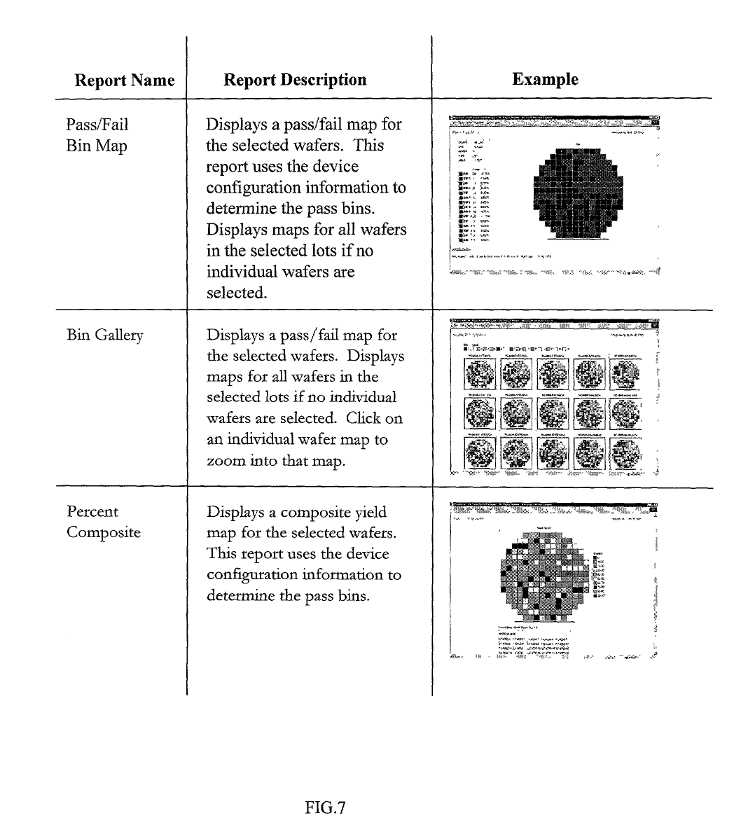

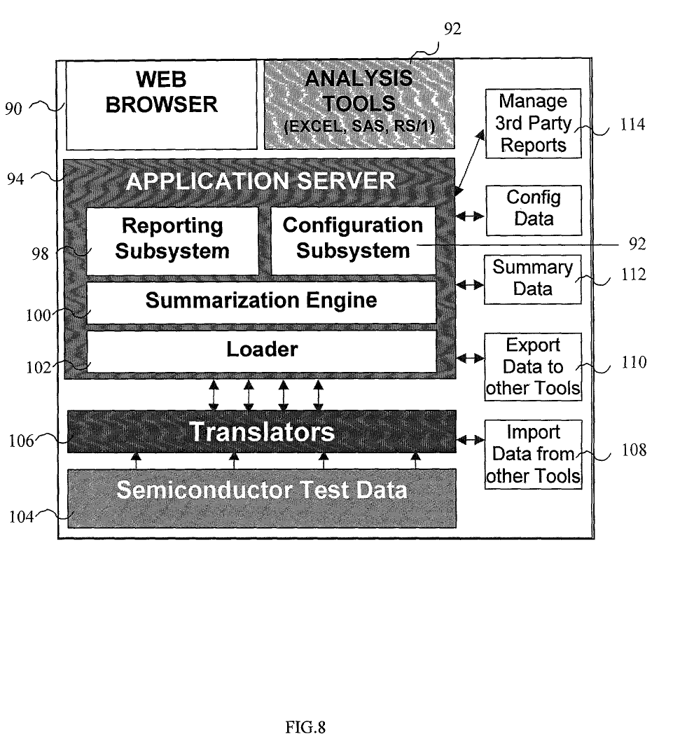

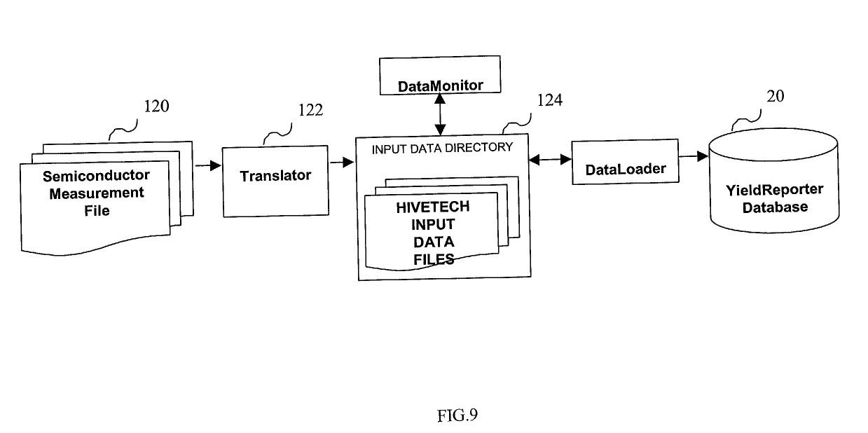

FIG. 7 illustrates typical standard reports such as yield parameter trends by equipment, standard yield parameter trends 82, equipment utilization reports 84, equipment status reports 86, probe card analysis, equipment tracking equipment commonality, and wafer maps 88. The present invention serves as a data management tool accessible via a web browser 90 using common analysis tools 92 that are accessed via application server 94. Application server 94 will consist of a configuration sub-system 96, a reporting system 98, and a summarization engine 100, and a loader 102. Test data 104 is received via translators 106. Additionally, translators 106 may import data 108 from additional tools. This data is loaded into application server 98 via loader 102. Loader 102 is capable of exporting the data to other data management systems 110. Additionally, summary data 112 is generated via summarization engine 100 to be stored within a correlational database. Additionally, application server 98 may manage third-party reports 114.

One important aspect of the present invention, in addition to the report generation and management is that, since it is accessible via web browser 90, remote access of that data is available any place that remote or network connectivity is available. Additionally, translator 106 and loader 102 allow data to be imported and exported to and from diverse data sources. Thus, the architecture of the present invention provides a system and method of unifying information from disparate sources.

FIG. 9 provides another illustration depicting the system and method of the present invention. In FIG. 9, a semiconductor measurement file or flat file 120 is received via translators 122 and input into a directory as part of a data management system accessible to software engine 16 or application server 98 of the present invention.

In addition to the report generation and templates provided by the present invention, the templates also provide the ability for the user to customize the generated reports. For example, corporate logos may be incorporated onto the reports or proprietary data markings, thus ensuring that a standard for the reports as identification of proprietary data or potential trade secret data can be put in place via the method of the present invention. The data management system of the present invention allows a hybrid of relational and structured directories and files. A relational database may relate lot/wafer history and product configuration information, while a hierarchical file database may correlate raw and summary data.

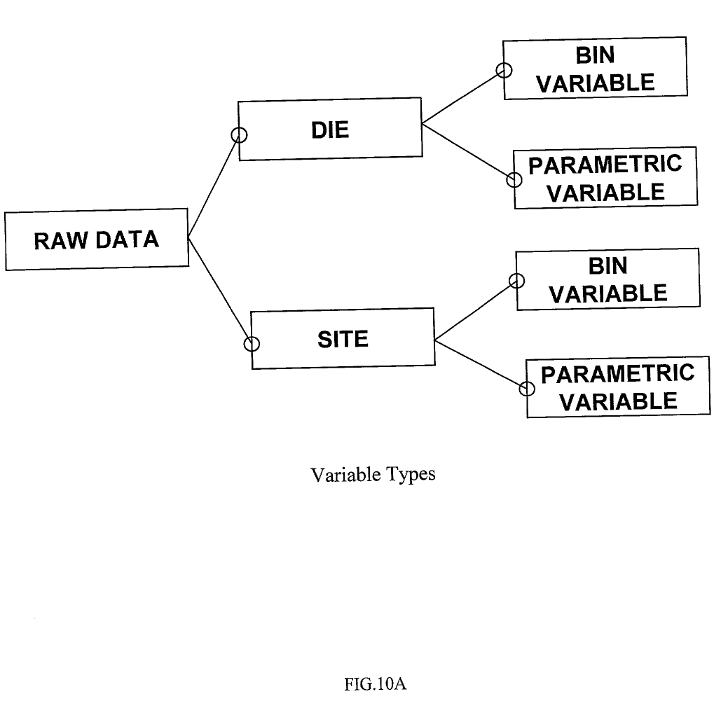

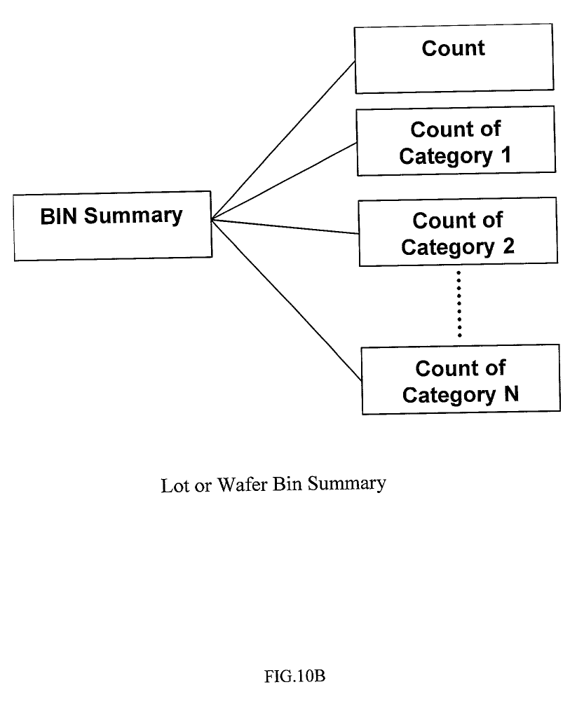

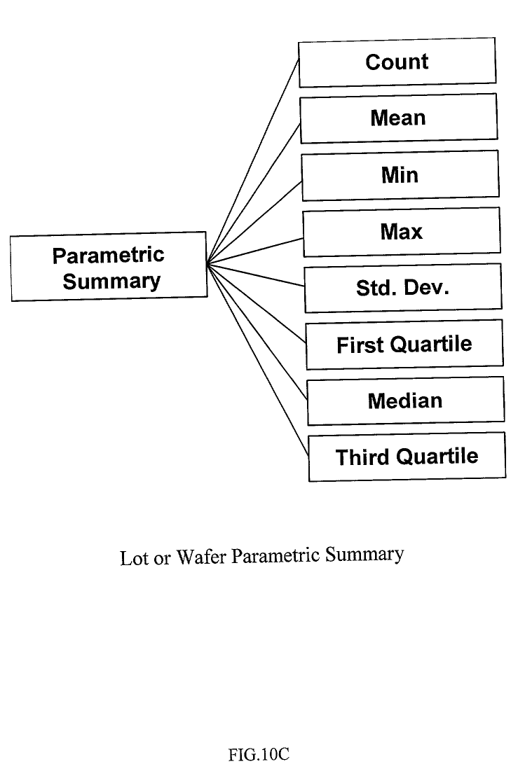

FIGS. 10A, 10B and 10C illustrate different variable types in a hierarchical fashion and a lot or wafer bin summary or parametric summary.

Although the present invention has been described in detail herein with reference to the illustrative embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons of ordinary skill in the art having reference to this description. It is contemplated that all such changes and additional embodiments are within the spirit and true scope of this invention as claimed below.

What is claimed is:

1. The present invention provides a method of dynamically publishing diverse data in a manufacturing environment, comprising the steps of:
gathering raw data from diverse sources;
translating said raw data into a user specified format;
loading said translated raw data into an application server;
summarizing and indexing said translated raw data;
receiving a user specified request for data;
relating said requested data to said translated raw data via said summarized and indexed translated raw data;
retrieving said translated raw data relating to said requested data; and
providing said translated raw data relating to said requested data to said user via a user interface.

2. The method of claim 1, further comprising the steps of:
analyzing said translated raw data relating to said requested data; and
visualizing said translated raw data relating to said requested data.

3. The method of claim 1, wherein said user interface is a web-browser coupled to said application server via a network connection.

4. The method of claim 3, wherein said network connection is an Internet connection.

5. The method of claim 1, wherein said application server is coupled to said diverse data sources via a network connection.

6. The method of claim 5, wherein said network connection is an Internet connection.

7. The method of claim 1, further comprising the step of storing said translated raw data in a data management system.

8. The method of claim 7, wherein said data management system comprises databases or flat file storage systems.

9. A system for dynamically publishing diverse data in a manufacturing environment, comprising:
diverse data sources from which raw data is gathered;
translator that translate said raw data into a user specified format;
loaders coupled to said translators to load said translated raw data into an application server;
a summarization engine that indexes said translated raw data and maintains said index within a relational database;
a user interface from which a user inputs a request for data; and
software instructions executed by the application server to retrieve and display said translated raw data relating to said requested data.

10. The system for dynamically publishing diverse data in a manufacturing environment of claim 9, further comprising:
analysis tools coupled to said application server operable to perform analysis of said translated raw data relating to said requested data as specified by said user; and
visualization tools coupled to said application server operable to visualize said translated raw data relating to said requested data via said user interface.

11. The system for dynamically publishing diverse data in a manufacturing environment of claim 9, wherein said user interface is a web-browser coupled to said application server via a network connection.

12. The system for dynamically publishing diverse data in a manufacturing environment of claim 11, wherein said network connection is an Internet connection.

13. The system for dynamically publishing diverse data in a manufacturing environment of claim 9, wherein said application server is coupled to said diverse data sources via a network connection.

14. The system for dynamically publishing diverse data in a manufacturing environment of claim 13, wherein said network connection is an Internet connection.

15. The system for dynamically publishing diverse data in a manufacturing environment of claim 9, further comprising a data management system in which to store said translated raw data in a data management system.

16. The system for dynamically publishing diverse data in a manufacturing environment of claim 15, wherein said data management system comprises databases or flat file storage systems.
